(19) United States
(12) Patent Application Publication
(10) Pub. No.: US 2012/0206259 A1
(43) Pub. Date: Aug. 16, 2012

(54) SYSTEM AND METHOD FOR REMOTE ALARM MANAGEMENT OF ONE OR MORE OBJECTS

(76) Inventor: EARNEST GASSAWAY, Oakland, CA (US)

(21) Appl. No.: 13/028,110

(22) Filed: Feb. 15, 2011

(51) Int. Cl. G08B 21/00

(52) U.S. Cl. 340/540

(57) ABSTRACT

A remote device for monitoring property protected by a security system. The security system has at least one physical sensor and comprises a module for wirelessly sending and receiving signals. The remote device comprises a receiver module and transmitter module whereby signals may be received and sent using various wireless technologies. A data port on the device allows a user to customize parameters according to user needs via a data connection between the device and computer, personal digital assistant or smart phone. A panic button on the remote device allows a user to alert a pre-selected designee. The remote device may also comprise a custom application running on a smart phone comprising that allows a user to monitor property. The remote device may be part of a security monitoring system or used in a method for monitoring the status of property protected by a security system.

### BACKGROUND OF THE INVENTION

The present disclosure relates in general to the existing industry for providing remote devices that can receive alerts. Remote alarm devices presently send and receive signals from a single piece of property such as a house, car, or garage door. In some arrangements, a keyless entry is facilitated through the use of a “FOB” control device and the depression of one or more buttons found on the face of the “FOB” or other such remote transmitter.

Today, the majority of remote devices can send and/or receive signals wirelessly. In the past, such wireless transmission was mainly done through radio frequency (RF). As technology has evolved new wireless means of sending and/or receiving signals have come into play. Some of these new technologies are Bluetooth, wireless 802.11a, b, g, n, or cellular. Despite advances in technology many wireless means used today still suffer from problems with range, interference, or extreme power usage. In the context of a remote transmitter with limited space and battery capacity, battery usage can be of particular importance. Furthermore, limited range limits the usefulness of a remote device to the end user as being out of range prevents said end user from receiving or sending critical alerts.

Existing remote devices can provide a few options of sending and/or receiving alerts. For example, some remote devices may alert a user via sound while others may use a vibration means. While these options may have been adequate in the past, today's user is often connected to others via text, email or other wireless means. Consequently, there exists a need for a user to receive and/or send alerts via a “FOB” using these alternative communication means. Existing remotes are also often limited by how many objects they can monitor, often only being able to monitor one at a time. Furthermore, existing remote devices are often limited by the number of buttons, size of the device, or limited customizability. Therefore, there exists an additional need to have a remote device that provides ease of use, customizability and provides for a remote device that provides the end user superior battery life, range, and the ability to monitor more than one object.

### SUMMARY OF THE INVENTION

The present invention is directed to a remote device (The Gass Remote Alarm™) that can monitor at least one property, providing the user a reliable and energy efficient manner of maintaining constant monitoring of at least one property.

In one embodiment of a system and method for remote monitoring of one or more properties, a remote device monitors property protected by a security system. The security system comprises a module for wirelessly sending and receiving signals. In this embodiment the remote device comprising a processor and a non-volatile memory module coupled to the processor, the non-volatile memory module capable of storing processor readable code, said processor readable code capable for programming the processor to monitor property protected by a security system. The security system further comprises a display coupled to the processor to display information to a user, a raised keypad comprising at least one button, and a port to allow recharging of a rechargeable battery, said rechargeable battery coupled inside the remote device for providing power to the remote device. In addition, the remote device further comprises a data port to allow communication between the remote device and a computer, personal digital device or smart phone, a panic button wherein upon pressing the panic button the panic button alerts a pre-selected designee, the pre-selected designee selected from the group consisting of a local police station, a monitoring system, and a customized user-defined designee, and a volume control switch. The remote device further comprises a receiver module coupled to the processor, said receiver module capable of receiving wireless signals from the security system and displaying the signals on the display, and a transmitter module coupled to the processor, the transmitter module capable of sending wireless signals. The remote device monitors more than one property protected by a security system with the security system comprising at least one physical security sensor for detecting security violations in one or more zones and upon detection of a security violation generating an alert, said at least one sensor having at least a tripped and a non-tripped state, wherein said at least one physical security sensor further comprises a wireless communications module for communication between the one physical security sensor and the remote device for monitoring.

In another embodiment of a system and method for remote monitoring of one or more properties, the remote device simultaneously sends and receives signals from one or more properties

In yet another embodiment of a system and method for remote monitoring of one or more properties, the remote device asynchronously sends and receives signals from one or more properties.

In one embodiment of a system and method for remote monitoring of one or more properties, the remote device further comprises a vibration module for indicating receipt of a signal from said security system, a visual indication module comprising at least one light wherein said light illuminates upon receipt of a signal from said security system, an audible module for indicating receipt of a signal from said security system, said audible module transmitted to a user via a speaker, and non volatile memory to store an email, phone number, url or other data necessary to facilitate wireless communication with said remote device.

In another embodiment of a system and method for remote monitoring of one or more properties, the transmitter module is capable of sending wireless signals via 802.11 wireless protocol, Bluetooth, radio frequency (RF), infrared frequency (IR), or a cellular network.

In yet another embodiment of a system and method for remote monitoring of one or more properties, the receiver module is capable of receiving wireless signals via 802.11 wireless protocol, Bluetooth, radio frequency (RF), infrared frequency (IR), or a cellular network.

In another embodiment of a system and method for remote monitoring of one or more properties, the data port allows a data connection between said remote device and a computer, personal digital assistant or smart phone, said data connection providing a user the option to customize parameters according to user needs, said parameters comprising: vibration module for indicating receipt of a signal, audible module for indicating receipt of a signal, visual module for indicating receipt of a signal, panic button for alerting a designee, transmission module, and a receiver module.

In yet another embodiment of a system and method for remote monitoring of one or more properties, the parameters are chosen from a web interface accessed via a computer, personal digital assistant, or smart phone, said web interface providing a user the option to customize said vibration module, said audible module, said visual module, said panic button for alerting a designee, said transmission module, and said receiver module whereby upon selecting desired customization options said customization options are transmitted to said remote device via said data connection and stored in said non-volatile memory as processor readable code, said processor readable code capable for programming said processor to execute said parameters.

In one embodiment of a system and method for remote monitoring of one or more properties, a remote device for monitoring property protected by a security system, said security system comprising a module for wirelessly sending and receiving signals to a remote device, the remote device comprising a custom application designed for installation and use on a smart phone. The custom application coupled with a smart phone comprises a processor, a non-volatile memory module coupled to said processor, the non-volatile memory module capable of storing processor readable code, said processor readable code capable for programming said processor to monitor property protected by a security system, a display coupled to said processor to display information to a user, input module for accessing information on said display, a port to allow recharging of a rechargeable battery, said rechargeable battery being coupled inside the smart phone for providing power to said smart phone, a port to allow communication between said smart phone and a computer, personal digital device or smart phone, a volume control switch, a vibration module, a receiver module coupled to the processor, said receiver module capable of receiving wireless signals from the security system and displaying said signals on said display, and a transmitter module coupled to the processor, said transmitter capable of sending wireless signals. Said remote device monitors more than one property protected by a security system. Furthermore, the security system comprises at least one physical security sensor for detecting security violations in one or more zones and upon detection of a security violation generating an alert, said at least one sensor having at least a tripped and a non-tripped state, wherein said at least one physical security sensor further comprises a wireless communications module for communication between the one physical security sensor and the remote device for monitoring.

In one embodiment of a system and method for remote monitoring of one or more properties, a remote device for monitoring property protected by a security system, the custom application provides for a custom user interface displayed on said display, wherein said custom user interface further provides a panic for a panic button wherein upon pressing the panic button said panic button alerts a pre-selected designee, the pre-selected designee selected from the group consisting of a local police station, a monitoring system, and a customized user-defined designee.

In another embodiment of a system and method for remote monitoring of one or more properties, a remote device for monitoring property protected by a security system, the alert is wirelessly sent from said security system to said remote device, said alert selected from the group consisting of email, text, voip call, cellular telephone call, vibration alert module, visual alert module, and audible alert module

In yet another embodiment of a system and method for remote monitoring of one or more properties, the transmitter module is capable of sending wireless signals via 802.11 wireless protocol, Bluetooth, or a cellular network.

In another embodiment of a system and method for remote monitoring of one or more properties, the receiver module is capable of receiving wireless signals via 802.11 wireless protocol, Bluetooth, radio frequency (RF), infrared frequency (IR), or a cellular network.

In one embodiment of a system and method for remote monitoring of one or more properties, the data port allows a data connection between said remote device and a computer, personal digital assistant or smart phone, said data connection providing a user the option to customize parameters according to user needs, said parameters comprising a vibration module for indicating receipt of a signal, an audible module for indicating receipt of a signal, a visual module for indicating receipt of a signal, a panic button for alerting a designee, a transmission module, and a receiver module.

In another embodiment of a system and method for remote monitoring of one or more properties, the parameters are chosen from a web interface accessed via a computer, personal digital assistant, or smart phone, said web interface providing a user the option to customize said vibration module, said audible module, said visual module, said panic button for alerting a designee, said transmission module, and said receiver module whereby upon selecting desired customization options said customization options are transmitted to said remote device via said data connection and stored in said non-volatile memory as processor readable code, said processor readable code capable for programming said processor to execute said parameters.

In yet another embodiment of a system and method for remote monitoring of one or more properties, the remote device asynchronously sends and receives signals from one or more properties

In yet another embodiment of a system and method for remote monitoring of one or more properties, the remote device asynchronously sends and receives signals from one or more properties.

In one embodiment of method for monitoring the status of property protected by a security system with a remote device, the method comprising the steps of installing a security system to monitory property, said security system comprising at least one physical security sensor for detecting security violations in one or more zones and upon detection of a security violation generating an alert, said at least one sensor having at least a tripped and a non-tripped state, and wherein said security system further comprises a wireless communication module for communication between said at least one physical security sensor and a remote device for monitoring, customizing the notification module via a data port wherein said data port allows a data connection between said remote device and a computer, personal digital assistant or smart phone, said notification module selected from the group consisting of vibration module, audible module, and visual module, customizing the transmission module via a data port wherein said data port allows a data connection between said remote device and a computer, personal digital assistant or smart phone, said notification module selected from the group consisting of 802.11 wireless protocol, Bluetooth, radio frequency (RF), infrared frequency (IR), and a cellular network, customizing the receiver module via a data port wherein said data port allows a data connection between said remote device and a computer, personal digital assistant or smart phone, said notification module selected from the group consisting of 802.11 wireless protocol, Bluetooth, radio frequency (RF), infrared frequency (IR), and a cellular network, and monitoring notifications received on said remote device, said notifications selected from the group consisting of visually displayed as text on a display coupled to a processor, visually displayed via illumination of a light, audibly indicated via notification through a speaker coupled to the remote device, and indicated via a vibration module coupled to said remote device.

In another embodiment of method for monitoring the status of property protected by a security system with a remote device, the text on a display coupled to a processor is selected from the group consisting of a text message, email, and hyperlink.

In yet another embodiment of a system and method for remote monitoring of one or more properties, a security monitoring system for at least one property, comprises at least one physical security sensor for detecting security violations in one or more zones and upon detection of a security violation generating an alert, said at least one sensor having at least a tripped and a non-tripped state. The security monitoring system further comprises a wireless communication module for communication between said at least one physical security sensor and a remote device for monitoring property and at least one remote device for monitoring property, said remote device comprising: a programmable memory module coupled to said processor, the non-volatile memory module capable of storing code executed by the processor, a display coupled to said processor to display information to a user, a raised keypad comprising at least one button, a port to allow recharging of a rechargeable battery, said rechargeable battery being coupled inside the remote device for providing power to said remote device, a data port to allow communication between said remote device and a computer, personal digital device or smart phone, a panic button wherein upon pressing the panic button said panic button alerts a pre-selected designee, the pre-selected designee selected from the group consisting of a local police station, a monitoring system, and a customized user-defined designee, a volume control switch, a receiver module coupled to the processor, said receiver module capable of receiving wireless signals from at least one security sensor and displaying said signals on said display, and a transmitter module coupled to the processor, said transmitter capable of sending wireless signals.

In yet another embodiment of a system and method for remote monitoring of one or more properties, a security monitoring system for at least one property, wherein said wireless communication module comprises a transmitter capable of sending wireless signals.

In yet another embodiment of a system and method for remote monitoring of one or more properties, a security monitoring system for at least one property, wherein the wireless communications module is selected from the group consisting of cellular transmitter, 802.11 wireless transmitter, Radio, and Bluetooth transmitter.

In one embodiment of a system and method for remote monitoring of one or more properties, a security monitoring system for at least one property, the alert is wirelessly sent from said security system to said remote device, said alert selected from the group consisting of email, text, voip call, cellular telephone call, vibration alert module, visual alert module, and audible alert module.

In one embodiment of a system and method for remote monitoring of one or more properties, a security monitoring system for at least one property, the non-volatile memory stores a user-selected email, phone number, url or other data necessary to facilitate wireless communication with said remote device.

In yet another embodiment of a system and method for remote monitoring of one or more properties, the remote device further comprises a processor running processor executable code stored on said non-volatile memory wherein said processor is coupled to the transmitting and receiving module, wherein said processor executable code allows said processor to use said transmitting and receiving module to scan for and detect which wireless communication standard will currently offer the best combination of coverage and battery usage in said remote device, wherein upon detection of the best combination of coverage and battery usage said processor selects which wireless communication module should be used by said transmitting and receiving module.

In yet another embodiment of a system and method for remote monitoring of one or more properties, the remote device further comprises a processor running processor executable code that scans for available wireless networks at predetermined intervals for the best combination of coverage and battery usage, said intervals selected from the group consisting of continuous, hourly, every half hour, every fifteen minutes, every five minutes, and user-defined intervals.

### BRIEF DESCRIPTION OF THE DRAWINGS

FIG. 1 is a diagram depicting a remote device for monitoring property.

FIG. 2 is a diagram depicting another embodiment of a remote device for monitoring property.

FIG. 3 is a diagram depicting another embodiment of a remote device for monitoring property.

FIG. 4 is a depiction of a web interface that a user can use to customize parameters of the remote device

FIG. 5 is a diagram depicting another embodiment of a remote device for monitoring property.

FIG. 6 is a flow chart depicting a method for monitoring the status of property protected by a security system with a remote device.

FIG. 7 is a depiction of a security monitoring system for at least one property.

FIG. 8 is a block diagram illustrating components of an exemplary operating environment in which various embodiments of the present invention may be implemented.

FIG. 9 is a depiction of exemplary operating environments, components and technology.

### DETAILED DESCRIPTION OF THE DRAWINGS

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

References in the specification to “one embodiment,” “an embodiment,” “an example embodiment,” etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to affect such feature, structure or characteristic in connection with other embodiments whether or not explicitly described.

Parts of the description are presented using terminology commonly employed by those of ordinary skill in the art to convey the substance of their work to others of ordinary skill in the art.

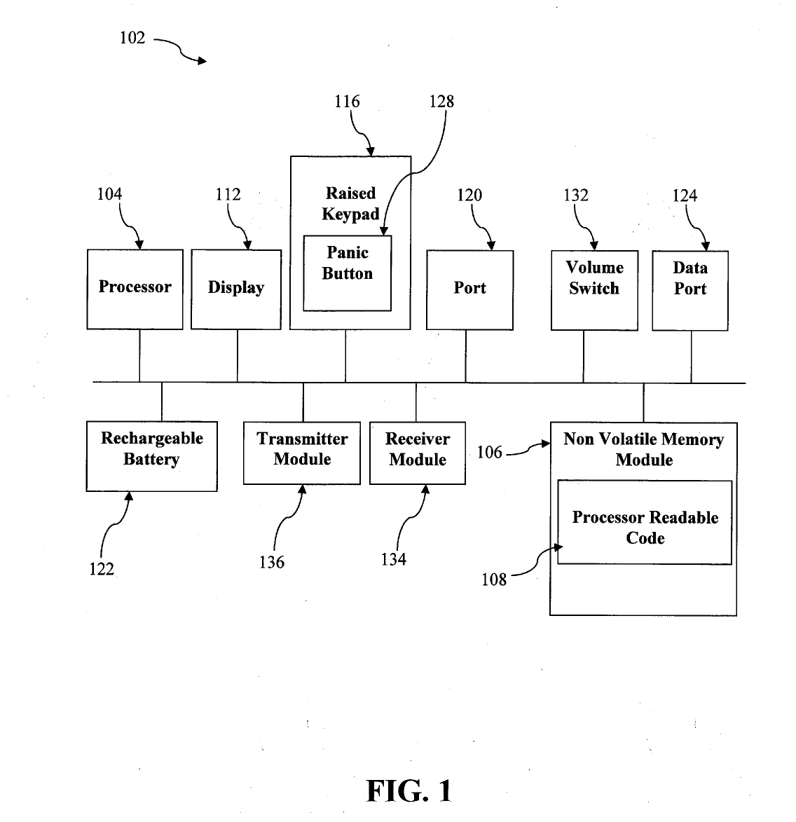

FIG. 1 is an illustration showing the elements used in a remote device for monitoring property protected by a security system. A remote device 102 for monitoring property (not shown) comprises one or more components, including a processor 104. Coupled to the processor 104 is a non-volatile memory module 106, the non-volatile memory module 106 capable of storing processor readable code 108. The processor readable code 108 is capable for programming the processor 104 to monitor property protected by a security system (not shown). A display 112 is also coupled to the processor 104 to display information to a user. Coupled to the remote device 102 is a raised keypad 116 comprising at least one button. A port 120 to allow recharging of a rechargeable battery 122 is located on the remote device 102. However, one of ordinary skill in the art will realize the port 120 may be placed in various locations on the remote device 102 such as the bottom or sides. Furthermore, the port 120 may be a port well known in the art (such as usb, micro-usb, or mini-usb) or one of custom design such that the port 120 will only work with the remote device 102. The rechargeable battery 122 is placed inside the remote device 102 and powers the remote device 102. The rechargeable battery 122 may be lithium-ion, nickel metal hydride, or other types well known in the art. A data port 124 is located on the remote device 102. However, one of ordinary skill in the art will realize the data port 124 may be placed in various locations on the remote device 102 such as the bottom or sides. The data port 124 may also be of different types known in the art such as usb, mini-usb, or micro-usb. The data port 124 may also be of a custom design such that the data port 124 will only work with the remote device 102. The data port 124 allows for communication between the remote device 102 and a computer, personal digital device, or a smart phone (not shown). One of ordinary skill in the art will realize the security system herein described may be chosen from a variety of 3^{rd} party solutions so long as it contains functionality as disclosed.

A panic button 128 is also coupled to the remote device 102 and may be placed in a variety of locations. A volume switch 132 is also coupled to the remote device 102, and is also located on the remote device 102. However, one of ordinary skill in the art will realize the volume switch 132 may be placed in a variety of locations on the remote device 102. A receiver module 134 is located inside the remote device 102 and is coupled to the processor 104. The receiver module 134 is capable of receiving wireless signals from the security system and displaying these signals on the display 112. A transmitter module 136 is also located inside the remote device 102 and is coupled to the processor 104. The remote device 102 is capable of monitoring more than one property 108 either synchronously or asynchronously. Both the transmitter module and the receiver module may communicate using technology known in the art such as wifi, Bluetooth, radio, cellular and other technologies. The security system monitoring at least one property is comprised of at least one physical sensor for detecting security violations in one or more zones and upon detection of a violation generating an alert. One of ordinary skill in the art will appreciate the physical sensor may monitor for violations using technology well known in the art such as infrared, laser, visual means or other technologies. The physical sensor has at least a tripped and a non-tripped state. The physical sensor also comprises a wireless communications module for communication between the physical sensor and the remote device 102.

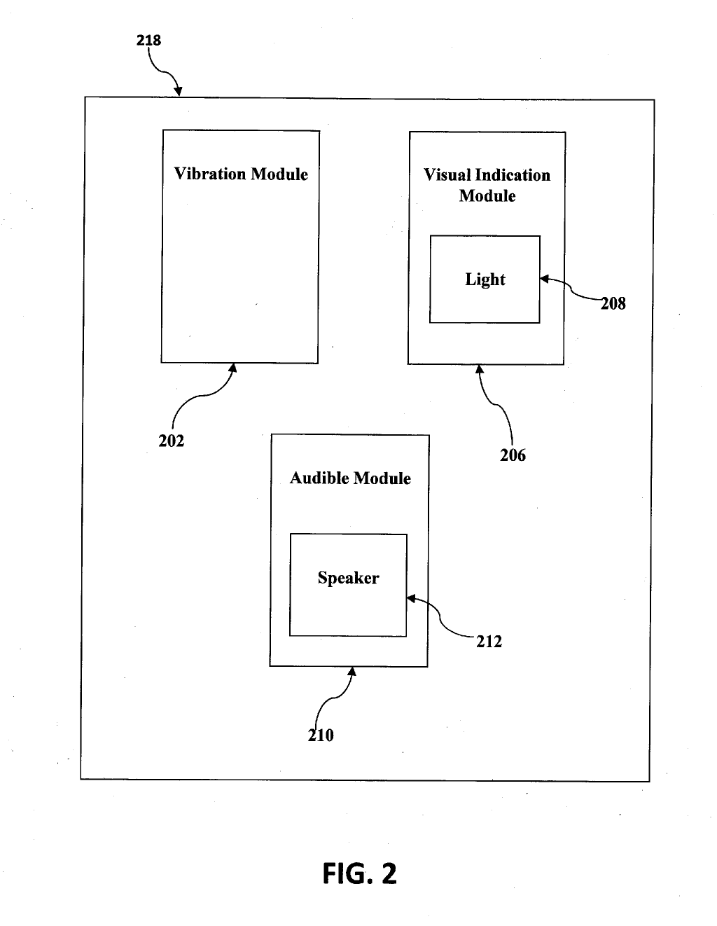

FIG. 2 is an illustration of a remote device comprising further elements. In this embodiment the remote device 218 further comprises a vibration module 202 for indicating receipt of a signal from a security system, a visual indication module 206 comprising at least one light 208 wherein the light 208 illuminates upon receipt of a signal from the security system, an audible module 210 for indicating receipt of a signal from the security system 204 with the audible module 210 transmitted to a user via a speaker 212, and non volatile memory to store an email, phone number, url or other data necessary to facilitate wireless communication between a security system and the remote device 218. The transmitter module and receiver module are compatible wireless signals such as those sent via 802.11 wireless protocols, Bluetooth, radio frequency (RF), infrared frequency (IR), or a cellular network. Those of ordinary skill in the art will realize this embodiment encompasses different protocols within 802.11, cellular networks, Bluetooth and other wireless technologies.

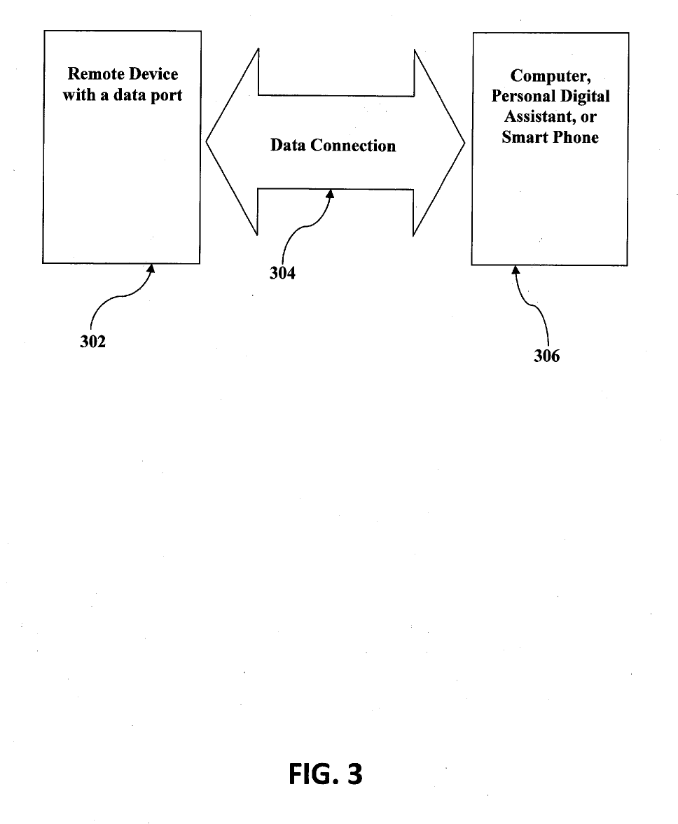

FIG. 3 is an illustration showing a remote device 302 with a data port. The data port allows a data connection 304 between the remote device 302 and a computer, personal digital assistant or smart phone 306, the data connection 304 providing a user the option to customize parameters according to user needs. Those of ordinary skill in the art will realize that the term “computer” is used in the broadest possible way such that tablets and other computer form factors are contemplated. The parameters that can be customized comprise a vibration module for indicating receipt of a signal, an audible module for indicating receipt of a signal, a visual module for indicating receipt of a signal, a panic button for alerting a designee, a transmission module, and a receiver module.

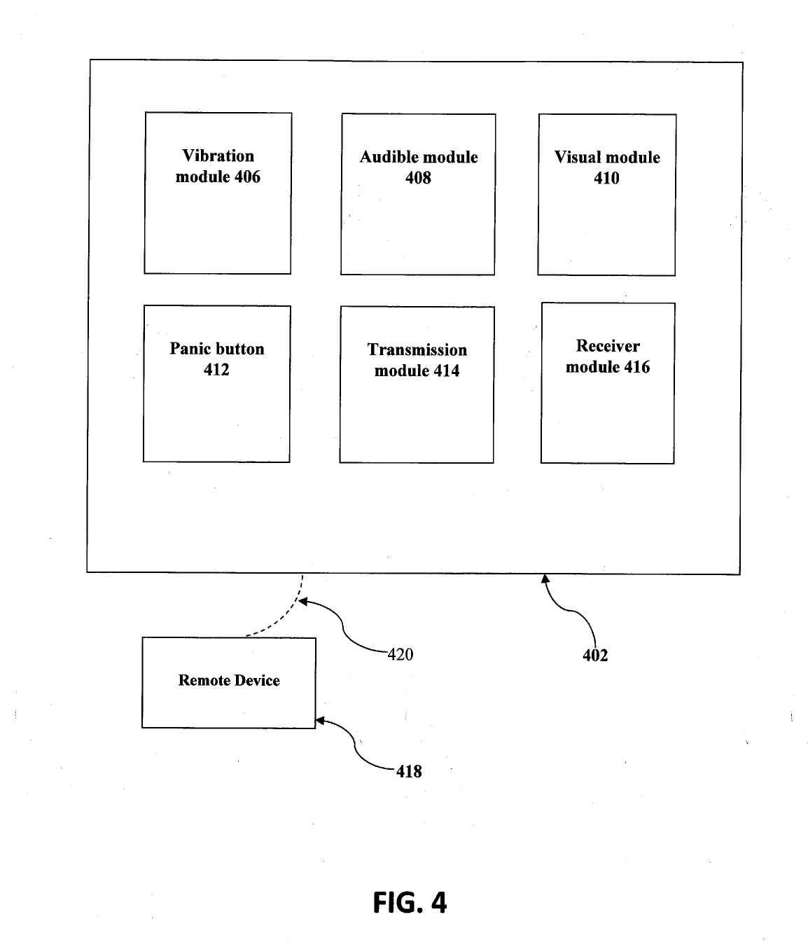

FIG. 4 is an illustration showing a web interface 402 that presents parameters that a user can customize. The parameters are chosen from a web interface 402 accessed via a computer, personal digital assistant, or smart phone, said web interface 402 providing a user the option to customize said vibration module 406, said audible module 408, said visual module 410, said panic button 412 for alerting a designee, said transmission module 414, and said receiver module 416 whereby upon selecting desired customization options said customization options are transmitted to a remote device 418 via a data connection 420 and stored in non-volatile memory as processor readable code, said processor readable code capable for programming said processor to execute said parameters.

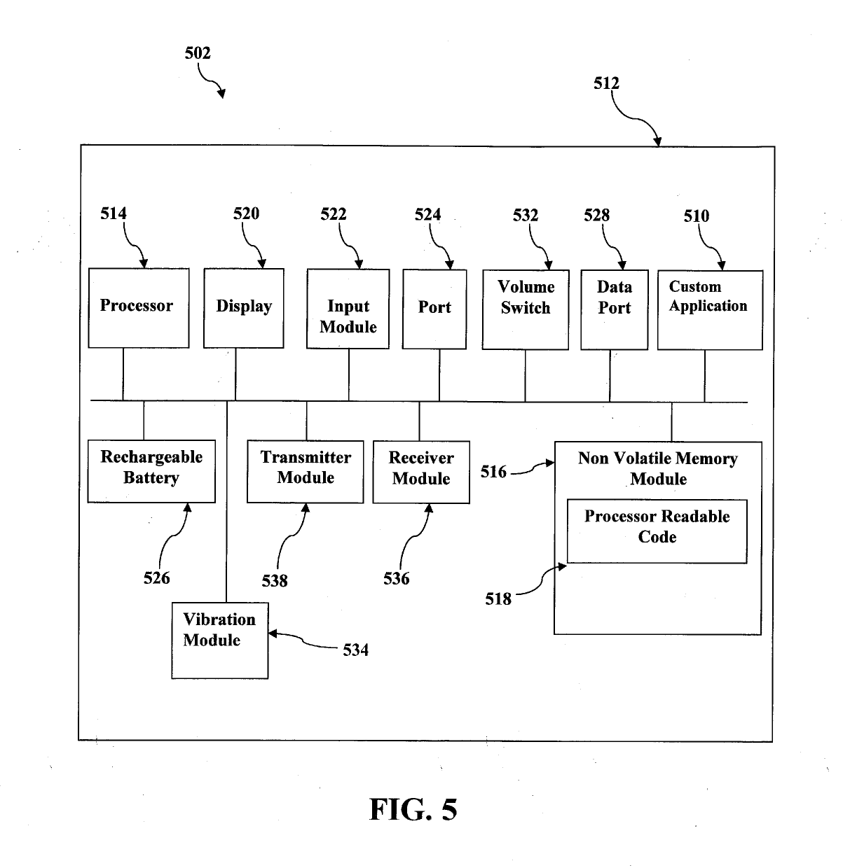

FIG. 5 is an illustration depicting another embodiment for remote monitoring of one or more properties. In this embodiment a remote 502 device for monitoring property is protected by a security system, the security system comprising a module for wirelessly sending and receiving signals to a remote device 502. The remote device 502 comprises a custom application 510 designed for installation and use on a smart phone 512. The custom application 510 coupled with a smart phone 512 comprises a processor 514, a non-volatile memory module 516 coupled to the processor 514, the non-volatile memory module capable of storing processor readable code 518, said processor readable code 518 capable for programming the processor 514 to monitor property protected by a security system. A display 520 is also coupled to the processor 514 to display information to a user. An input module 522 for accessing information is coupled the display 520. The custom application coupled with a smart phone also comprises a port 524 to allow recharging of a rechargeable battery 526, the rechargeable battery 526 being coupled inside the smart phone 512 for providing power to the smart phone 512. The custom application coupled with a smart phone also comprises a data port 528 to allow communication between the smart phone 512 and a computer, personal digital device or smart phone. A volume control switch 532, a vibration module 534, and a receiver module 536 coupled to the processor 514 are also coupled to the custom application that is coupled with a smart phone. The receiver module 536 is capable of receiving wireless signals from the security system and displaying the signals on the display 520. A transmitter module 538 is coupled to the processor 514, the transmitter module 538 capable of sending wireless signals. The remote device 502 monitors more than one property protected by a security system. Furthermore, the security system comprises at least one physical security sensor for detecting security violations in one or more zones and upon detection of a security violation generating an alert, said at least one physical security sensor having at least a tripped and a non-tripped state, wherein said at least one physical security sensor further comprises a wireless communications module for communication between the one physical security sensor and the remote device 502 for monitoring property.

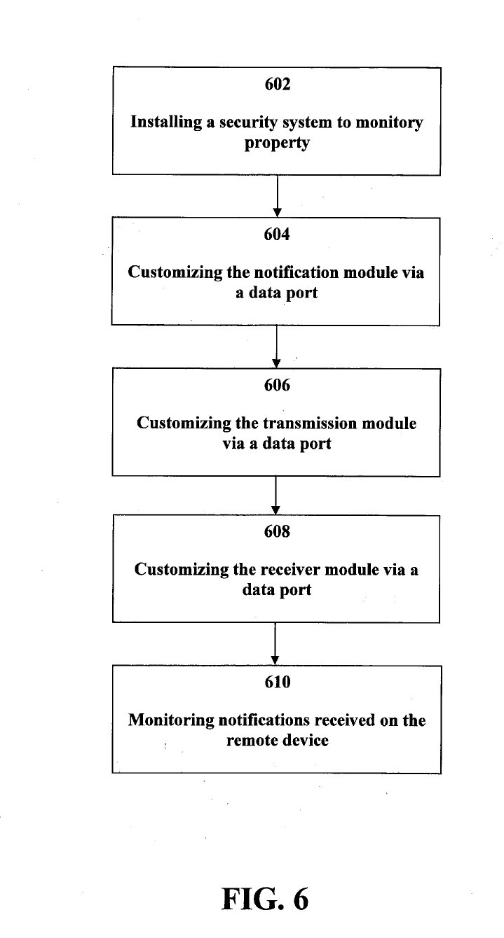

FIG. 6 is an exemplary block diagram illustrating a method for monitoring the status of property protected by a security system with a remote device. Although presented in a specific order, one having skill in the art will realize the order of the steps used in this method may be rearranged to suite different conditions or needs. The first step 602 involves installing a security system to monitory property, said security system comprising at least one physical security sensor for detecting security violations in one or more zones and upon detection of a security violation generating an alert, said at least one sensor having at least a tripped and a non-tripped state, and wherein said security system further comprises a wireless communication module for communication between said at least one physical security sensor and a remote device for monitoring. The second step 604 involves customizing the notification module via a data port wherein said data port allows a data connection between said remote device and a computer, personal digital assistant or smart phone, said notification module selected from the group consisting of vibration module, audible module, and visual module. The third step 606 involves customizing the transmission module via a data port wherein said data port allows a data connection between said remote device and a computer, personal digital assistant or smart phone, said notification module selected from the group consisting of 802.11 wireless protocol, Bluetooth, radio frequency (RF), infrared frequency (IR), and a cellular network. The fourth step 608 involves customizing the receiver module via a data port wherein said data port allows a data connection between said remote device and a computer, personal digital assistant or smart phone, said notification module selected from the group consisting of 802.11 wireless protocol, Bluetooth, radio frequency (RF), infrared frequency (IR), and a cellular network. The fifth step 610 involves monitoring notifications received on said remote device, said notifications selected from the group consisting of visually displayed as text on a display coupled to a processor, visually displayed via illumination of a light, audibly indicated via notification through a speaker coupled to the remote device, and indicated via a vibration module coupled to said remote device.

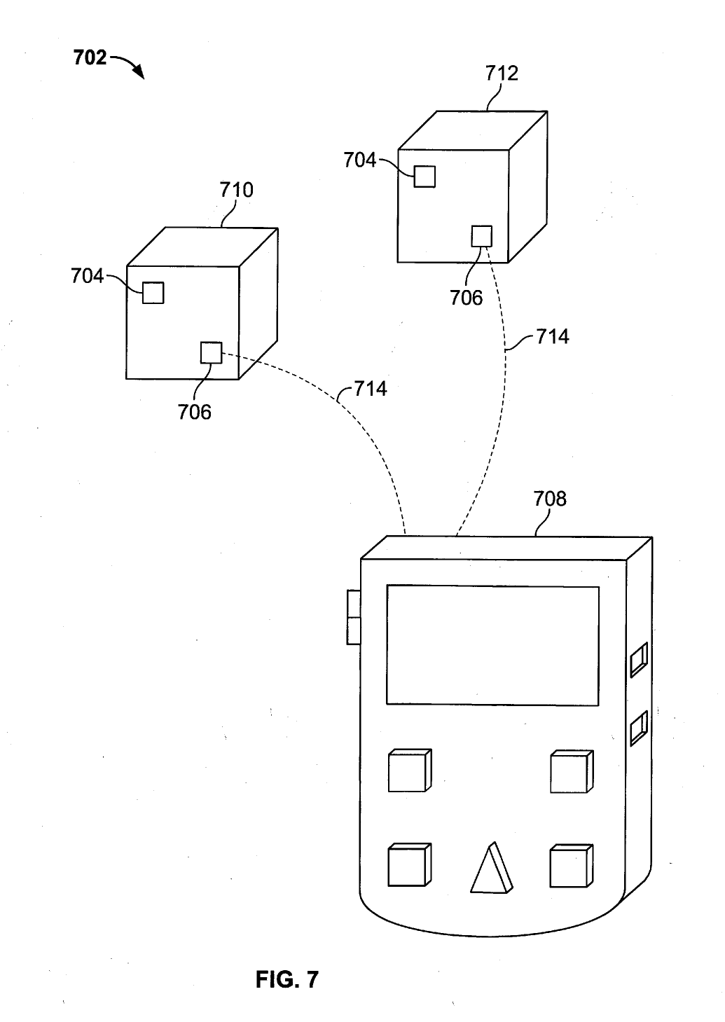

FIG. 7 is an illustration of a security monitoring system for at least one property. The security monitoring system 702 comprises at least one physical security sensor 704 for detecting security violations in one or more zones and upon detection of a security violation generating an alert, said at least one physical security sensor 704 having at least a tripped and a non-tripped state. The security monitoring system 702 further comprises a wireless communication module 706 for wireless communication 714 between at least one physical security sensor 704 and at least one remote device 708 (as shown, for example, in FIG. 1 or 5) for monitoring property 710, 712. The remote device 708 comprises a processor and a non-volatile memory module coupled to the processor. The non-volatile memory module is capable of storing processor executable code capable for programming the processor to monitor property protected by a security monitoring system. The remote device 708 further comprises a display coupled to the processor to display information to a user and a raised keypad comprising at least one button. The remote device 708 also comprises a port to allow recharging of a rechargeable battery, the rechargeable battery being coupled inside the remote device 708 for providing power to the remote device 708. The remote device 708 further comprises a data port to allow communication between the remote device 708 and a computer, personal digital device or smart phone. A panic button is also coupled to the remote device 708 wherein upon pressing the panic button the panic button alerts a pre-selected designee, the pre-selected designee selected from the group consisting of a local police station, a monitoring system, and a customized user-defined designee. The remote device 708 further comprises a volume control switch and a receiver module coupled to the processor, the receiver module capable of receiving wireless signals from at least one physical security sensor 704 and displaying the wireless signals on the display. The remote device 708 also comprises a transmitter module coupled to the processor, the transmitter module capable of sending wireless signals.

In another embodiment (not shown) a remote device that further comprises a processor running processor executable code stored on non-volatile memory wherein the processor is coupled to the transmitting and receiving module. The processor executable code allows the processor to use the transmitting and receiving module to scan for and detect which wireless communication standard will currently offer the best combination of coverage and battery usage in the remote device. Upon detection of the best combination of coverage and battery usage, the processor selects which wireless communication module should be used by the transmitting and receiving module.

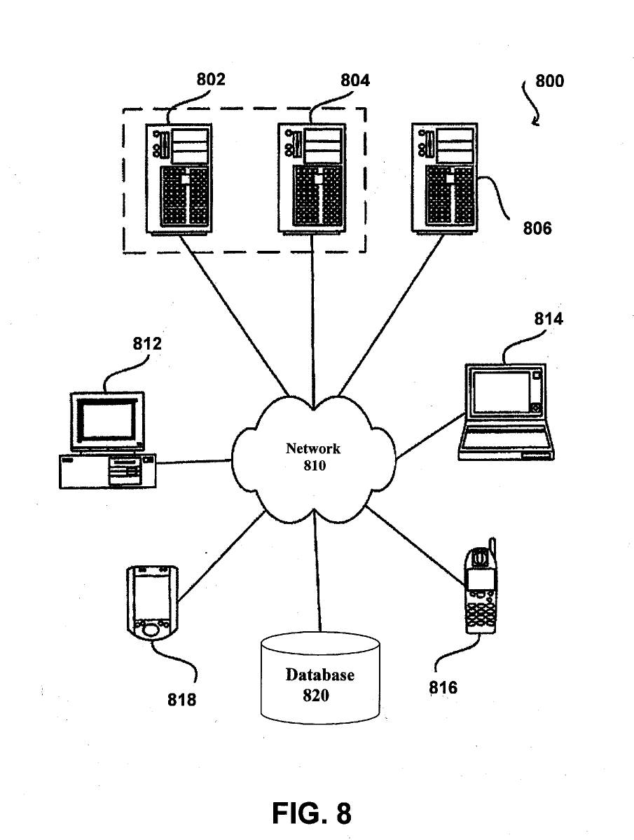

Exemplary Operating Environments, Components and Technology. FIG. 8 is a block diagram illustrating components of an exemplary operating environment in which various embodiments of the present invention may be implemented. The system 800 can include one or more user computers, computing devices, or processing devices 812, 814, 816, 818, which can be used to operate a client, such as a dedicated application, web browser, etc. The user computers 812, 814, 816, 818 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 812, 814, 816, 818 may also have any of a variety of applications, including one or more development systems, database client and/or server applications, and Web browser applications. Alternatively, the user computers 812, 814, 816, 818 may be any other electronic device, such as a thin-client computer, Internet-enabled gaming system, and/or personal messaging device, capable of communicating via a network (e.g., the network 810 described below) and/or displaying and navigating Web pages or other types of electronic documents. Although the exemplary system 800 is shown with four user computers, any number of user computers may be supported.

FIG. 8 is a diagram depicting another embodiment of a remote device for monitoring property In most embodiments, the system 800 includes some type of network 810. The network may can be any type of network familiar to those skilled in the art that can support data communications using any of a variety of commercially-available protocols, including without limitation TCP/IP, SNA, IPX, AppleTalk, and the like. Merely by way of example, the network 810 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 802, 804, 806 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 806) may be dedicated to running applications, such as a business application, a Web server, application server, etc. Such servers may be used to process requests from user computers 812, 814, 816, 818. The applications can also include any number of applications for controlling access to resources of the servers 802, 804, 806.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 812, 814, 816, 818. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 812, 814, 816, 818.

The system 800 may also include one or more databases 820. The database(s) 820 may reside in a variety of locations. By way of example, a database 820 may reside on a storage medium local to (and/or resident in) one or more of the computers 802, 804, 806, 812, 814, 816, 818. Alternatively, it may be remote from any or all of the computers 802, 804, 806, 812, 814, 816, 818, and/or in communication (e.g., via the network 810) with one or more of these. In a particular set of embodiments, the database 820 may reside in a storage-area network (“SAN”) familiar to those skilled in the art. Similarly, any necessary files for performing the functions attributed to the computers 802, 804, 806, 812, 814, 816, 818 may be stored locally on the respective computer and/or remotely, as appropriate. In one set of embodiments, the database 820 may be a relational database, such as Oracle 10g, that is adapted to store, update, and retrieve data in response to SQL-formatted commands.

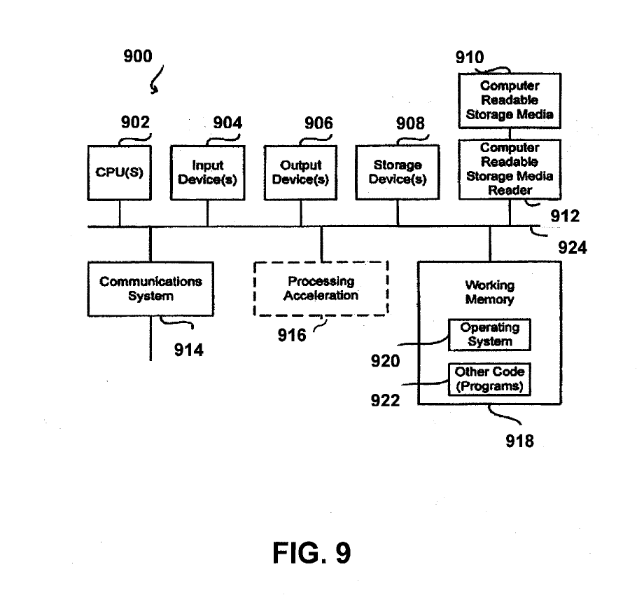

FIG. 9 illustrates an exemplary computer system 900, in which various embodiments of the present invention may be implemented. The system 900 may be used to implement any of the computer systems described above. The computer system 900 is shown comprising hardware elements that may be electrically coupled via a bus 924. The hardware elements may include one or more central processing units (CPUs) 902, one or more input devices 904 (e.g., a mouse, a keyboard, etc.), and one or more output devices 906 (e.g., a display device, a printer, etc.). The computer system 900 may also include one or more storage devices 908. By way of example, the storage device(s) 908 can include devices such as disk drives, optical storage devices, solid-state storage device such as a random access memory (“RAM”) and/or a read-only memory (“ROM”), which can be programmable, flash-updateable and/or the like.

The computer system 900 may additionally include a computer-readable storage media reader 912, a communications system 914 (e.g., a modem, a network card (wireless or wired), an infra-red communication device, etc.), and working memory 918, which may include RAM and ROM devices as described above. In some embodiments, the computer system 900 may also include a processing acceleration unit 916, which can include a digital signal processor DSP, a special-purpose processor, and/or the like.

The computer-readable storage media reader 912 can further be connected to a computer-readable storage medium 910, together (and, optionally, in combination with storage device(s) 908) comprehensively representing remote, local, fixed, and/or removable storage devices plus storage media for temporarily and/or more permanently containing, storing, transmitting, and retrieving computer-readable information. The communications system 914 may permit data to be exchanged with the network and/or any other computer described above with respect to the system 900.

The computer system 900 may also comprise software elements, shown as being currently located within a working memory 918, including an operating system 920 and/or other code 922, such as an application program (which may be a client application, Web browser, mid-tier application, RDBMS, etc.). It should be appreciated that alternate embodiments of a computer system 900 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A remote device for monitoring property protected by a security system, the security system comprising a module for wirelessly sending and receiving signals, the remote device comprising:
a processor;
a non-volatile memory module coupled to said processor, the non-volatile memory module capable of storing processor readable code, said processor readable code capable for programming said processor to monitor property protected by a security system;
a display coupled to said processor to display information to a user;
a raised keypad comprising at least one button;
a port to allow recharging of a rechargeable battery, said rechargeable battery coupled inside the remote device for providing power to said remote device;
a data port to allow communication between said remote device and a computer, personal digital device or smart phone;
a panic button wherein upon pressing the panic button said panic button alerts a pre-selected designee, the pre-selected designee selected from the group consisting of a local police station, a monitoring system, and a customized user-defined designee;
a volume control switch;
a receiver module coupled to the processor, said receiver module capable of receiving wireless signals from the security system and displaying said signals on said display;
a transmitter module coupled to the processor, said transmitter module capable of sending wireless signals;
wherein said remote device monitors more than one property protected by a security system; and
wherein said security system comprises at least one physical security sensor for detecting security violations in one or more zones and upon detection of a security violation generating an alert, said at least one sensor having at least a tripped and a non-tripped state, wherein said at least one physical security sensor further comprises a wireless communications module for communication between the one physical security sensor and the remote device for monitoring.

2. The remote device of claim 1 wherein said remote device simultaneously sends and receives signals from one or more properties.

3. The remote device of claim 1 wherein said remote device asynchronously sends and receives signals from one or more properties.

4. The remote device of claim 1 further comprising:
a vibration module for indicating receipt of a signal from said security system;
a visual indication module comprising at least one light wherein said light illuminates upon receipt of a signal from said security system;
an audible module for indicating receipt of a signal from said security system, said audible module transmitted to a user via a speaker; and
non volatile memory to store an email, phone number, url or other data necessary to facilitate wireless communication with said remote device.

5. The remote device of claim 1 wherein said transmitter module is capable of sending wireless signals via 802.11 wireless protocol, Bluetooth, radio frequency (RF), infrared frequency (IR), or a cellular network.

6. The remote device of claim 1 wherein said receiver module is capable of receiving wireless signals via 802.11 wireless protocol, Bluetooth, radio frequency (RF), infrared frequency (IR), or a cellular network.

7. The remote device of claim 1 wherein said data port allows a data connection between said remote device and a computer, personal digital assistant or smart phone, said data connection providing a user the option to customize parameters according to user needs, said parameters comprising:
a vibration module for indicating receipt of a signal;
an audible module for indicating receipt of a signal;
a visual module for indicating receipt of a signal;
a panic button for alerting a designee;
a transmission module; and
a receiver module.

8. The remote device of claim 7 wherein said parameters are chosen from a web interface accessed via a computer, personal digital assistant, or smart phone, said web interface providing a user the option to customize said vibration module, said audible module, said visual module, said panic button for alerting a designee, said transmission module, and said receiver module whereby upon selecting desired customization options said customization options are transmitted to said remote device via said data connection and stored in said non-volatile memory as processor readable code, said processor readable code capable for programming said processor to execute said parameters.

9. The remote device of claim 1, further comprising:
a security system for monitoring protected property, said security system comprising a module for wirelessly sending and receiving signals to a remote device, the remote device comprising a custom application designed for installation and use on a smart phone, wherein said custom application is coupled with a smart phone;
a processor;
a non-volatile memory module coupled to said processor, the non-volatile memory module capable of storing processor readable code, said processor readable code capable for programming said processor to monitor property protected by a security system;
a display coupled to said processor to display information to a user;
an input module for accessing information on said display;
a port to allow recharging of a rechargeable battery, said rechargeable battery being coupled inside the smart phone for providing power to said smart phone;
a port to allow communication between said smart phone and a computer, personal digital device or smart phone;
a volume control switch;
a vibration module;
a receiver module coupled to the processor, said receiver module capable of receiving wireless signals from the security system and displaying said signals on said display;
a transmitter module coupled to the processor, said transmitter capable of sending wireless signals;
wherein said remote device monitors more than one property protected by a security system; and
wherein said security system comprises at least one physical security sensor for detecting security violations in one or more zones and upon detection of a security violation generating an alert, said at least one sensor having at least a tripped and a non-tripped state, wherein said at least one physical security sensor further comprises a wireless communications module for communication between the one physical security sensor and the remote device for monitoring.

10. The remote device of claim 9 wherein said custom application provides for a custom user interface displayed on said display, wherein said custom user interface further provides a panic for a panic button wherein upon pressing the panic button said panic button alerts a pre-selected designee, the pre-selected designee selected from the group consisting of a local police station, a monitoring system, and a customized user-defined designee.

11. The remote device of claim 9 wherein said alert is wirelessly sent from said security system to said remote device, said alert selected from the group consisting of email, text, voip call, cellular telephone call, vibration alert module, visual alert module, and audible alert module.

12. The remote device of claim 9 wherein said transmitter module is capable of sending wireless signals via 802.11 wireless protocol, Bluetooth, or a cellular network.

13. The remote device of claim 9 wherein said receiver module is capable of receiving wireless signals via 802.11 wireless protocol, Bluetooth, radio frequency (RF), infrared frequency (IR), or a cellular network.

14. The remote device of claim 9 wherein said data port allows a data connection between said remote device and a computer, personal digital assistant or smart phone, said data connection providing a user the option to customize parameters according to user needs, said parameters comprising:
a vibration module for indicating receipt of a signal;
an audible module for indicating receipt of a signal;
a visual module for indicating receipt of a signal;
a panic button for alerting a designee;
a transmission module; and
a receiver module.

15. The remote device of claim 14 wherein said parameters are chosen from a web interface accessed via a computer, personal digital assistant, or smart phone, said web interface providing a user the option to customize said vibration module, said audible module, said visual module, said panic button for alerting a designee, said transmission module, and said receiver module whereby upon selecting desired customization options said customization options are transmitted to said remote device via said data connection and stored in said non-volatile memory as processor readable code, said processor readable code capable for programming said processor to execute said parameters.

16. The remote device of claim 9 wherein said remote device simultaneously sends and receives signals from one or more properties.

17. The remote device of claim 9 wherein said remote device asynchronously sends and receives signals from one or more properties.

18. A method for monitoring the status of property protected by a security system with a remote device, the method comprising the steps of:
installing a security system to monitory property, said security system comprising at least one physical security sensor for detecting security violations in one or more zones and upon detection of a security violation generating an alert, said at least one sensor having at least a tripped and a non-tripped state, and wherein said security system further comprises a wireless communication module for communication between said at least one physical security sensor and a remote device for monitoring customizing the notification module via a data port wherein said data port allows a data connection between said remote device and a computer, personal digital assistant or smart phone, said notification module selected from the group consisting of vibration module, audible module, and visual module;
customizing the transmission module via a data port wherein said data port allows a data connection between said remote device and a computer, personal digital assistant or smart phone, said notification module selected from the group consisting of 802.11 wireless protocol, Bluetooth, radio frequency (RF), infrared frequency (IR), and a cellular network;
customizing the receiver module via a data port wherein said data port allows a data connection between said remote device and a computer, personal digital assistant or smart phone, said notification module selected from the group consisting of 802.11 wireless protocol, Bluetooth, radio frequency (RF), infrared frequency (IR), and a cellular network; and
monitoring notifications received on said remote device, said notifications selected from the group consisting of visually displayed as text on a display coupled to a processor, visually displayed via illumination of a light, audibly indicated via notification through a speaker coupled to the remote device, and indicated via a vibration module coupled to said remote device.

19. The method for monitoring the status of property protected by a security system with a remote device of claim 16 wherein said text on a display coupled to a processor is selected from the group consisting of a text message, email, and hyperlink.

20. A security monitoring system for at least one property, the system comprising:
at least one physical security sensor for detecting security violations in one or more zones and upon detection of a security violation generating an alert, said at least one sensor having at least a tripped and a non-tripped state;
a wireless communication module for communication between said at least one physical security sensor and a remote device for monitoring;
at least one remote device for monitoring property, said remote device comprising:
a processor:
a non-volatile memory module coupled to said processor, the non-volatile memory module capable of storing processor readable code capable for programming said processor to monitor property protected by a security monitoring system;
a display coupled to said processor to display information to a user;
a raised keypad comprising at least one button;
a port to allow recharging of a rechargeable battery, said rechargeable battery being coupled inside the remote device for providing power to said remote device;
a data port to allow communication between said remote device and a computer, personal digital device or smart phone;
a panic button wherein upon pressing the panic button said panic button alerts a pre-selected designee, the pre-selected designee selected from the group consisting of a local police station, a monitoring system, and a customized user-defined designee;
a volume control switch;
a receiver module coupled to the processor, said receiver module capable of receiving wireless signals from at least one physical security sensor and displaying said wireless signals on said display; and
a transmitter module coupled to the processor, said transmitter module capable of sending wireless signals.

21. The security monitoring system of claim 18 wherein said wireless communication module comprises a transmitter capable of sending wireless signals.

22. The security system of claim 18 wherein said wireless communications module is selected from the group consisting of cellular transmitter, 802.11 wireless transmitter, Radio, and Bluetooth transmitter.

23. The security monitoring system of claim 18 wherein said alert is wirelessly sent from said security system to said remote device, said alert selected from the group consisting of email, text, voip call, cellular telephone call, vibration alert module, visual alert module, and audible alert module.

24. The security monitoring system of claim 18, wherein said non-volatile memory stores a user-selected email, phone number, url or other data necessary to facilitate wireless communication with said remote device.

25. The remote device of claim 1 further comprising
a processor running processor executable code stored on said non-volatile memory wherein said processor is coupled to the transmitting and receiving module, wherein said processor executable code allows said processor to use said transmitting and receiving module to scan for and detect which wireless communication standard will currently offer the best combination of coverage and battery usage in said remote device, wherein upon detection of the best combination of coverage and battery usage said processor selects which wireless communication module should be used by said transmitting and receiving module.

26. The remote device of claim 23 wherein said processor running processor executable code scans for available wireless networks at predetermined intervals for the best combination of coverage and battery usage, said intervals selected from the group consisting of continuous, hourly, every half hour, every fifteen minutes, every five minutes, and user-defined intervals.
